(19) United States
(12) Patent Application Publication
(10) Pub. No.: US 2026/0184439 A1
(43) Pub. Date: Jul. 2, 2026

(54) AIRCRAFT SHADE FABRIC PRESERVATION SYSTEM

(71) Applicant: AEROSPACE TECHNOLOGIES GROUP, INC., Boca Raton, FL (US)

(72) Inventor: Mario Ceste, Boca Raton, FL (US)

(21) Appl. No.: 19/435,126

(22) Filed: Dec. 29, 2025

Related U.S. Application Data
(60) Provisional application No. 63/739,207, filed on Dec. 27, 2024.

(51) Int. Cl. B64F 5/40; B64C 1/14; B64D 45/00

(52) U.S. Cl. CPC B64F 5/40; B64C 1/1484; B64D 45/00; B64D 2045/0085

(57) ABSTRACT

An aircraft window shade preservation system and method maintain the integrity of pleated fabric shades by automating restorative compression. A movable shade with pleated material is driven by a motor between open and closed positions, with a controller halting movement at nominal limits during normal operation. A processor tracks cycle counts and age, executing a pre-programmed maintenance sequence that exceeds these limits to compress the fabric between rigid top and bottom members, restoring creases. Position detection uses sensors or motor current feedback. Compression intensity and frequency adjust dynamically based on age and/or cycle life of the shade, extending shade lifespan, reducing maintenance costs, and enhancing cabin aesthetics without overstressing components.

### CROSS-REFERENCE TO RELATED APPLICATION

This application claims priority to U.S. Provisional Ser. No. 63/739,207 filed Dec. 27, 2024, the entirety of which is incorporated by reference.

### FIELD OF THE INVENTION

The present invention relates generally to foldable window shades in aircraft, and, more particularly, relates to methods and systems of maintaining the integrity of the window shade material.

### BACKGROUND OF THE INVENTION

Aircraft window shades are typically made of pleated fabric that bends along horizontal folds or creases as the shades are raised and lowered. Over time, the repetitive motion and aging of the fabric cause these pleats to lose their crisp shape, similar to how the creases in men's pants become less distinct after use. In garments, such creases are restored through a pressing process, often using heat, mechanical pressure, or both. Similarly, the pleats in aircraft window shades can be restored through periodic pressing and flexing to maintain their shape and appearance. However, no current system automates this restoration process, resulting in premature wear and loss of functionality for these shades.

Therefore, a need exists to overcome the problems with the prior art as discussed above.

### SUMMARY OF THE INVENTION

In accordance with some embodiments of the inventive disclosure, there is provided an aircraft shade fabric preservation system that includes a moveable window shade of a pleated fabric material, a motor operable to move the moveable window shade from an open position to a closed position, a controller communicatively coupled to the motor and operable to cause the motor to stop the movable window shade at a normal operating open position limit and at a normal operating closed position limit, and a processor communicatively coupled to the controller and operable to execute an algorithm that causes the controller to cause the moveable window shade to perform a pre-programmed sequence of movements via the motor to restore the pleats of the shade fabric. The pre-programmed sequence of movements including causing the motor to stop the movable window shade at a position that exceeds the normal operating open position limit and at a position that exceeds the normal operating closed position limit.

In accordance with a further feature, the normal operating open position is detected by the sensing current spikes on the motor's current input.

In accordance with a further feature, the normal operating closed position is detected by the sensing current spikes on the motor's current input.

In accordance with a further feature, there is also a sensor communicatively coupled to the motor or to the controller and operable to detect when the normal operating open position of the moveable window shade has been reached.

In accordance with a further feature, there is also a sensor communicatively coupled to the motor or to the controller and operable to detect when the normal operating closed position of the moveable window shade has been reached.

In accordance with a further feature, there is also a non-volatile memory coupled to the processor for storing the cycle count and a cycle table defining compression levels and intervals for the pre-programmed sequence.

In accordance with a further feature, the processor is further operable to track an age of the pleated fabric material and adjust a duration or force of exceeding the normal operating open position limit based on the age.

In accordance with a further feature, there is also a top rigid member and a bottom rigid member attached to opposite ends of the pleated fabric material, wherein exceeding the normal operating open position limit compresses the pleated fabric material between the top rigid member and the bottom rigid member.

In accordance with a further feature, the pre-programmed sequence includes a series of partial movements at varying speeds and distances prior to exceeding the normal operating open position limit.

In accordance with a further feature, there is also a pulley system operably coupled to the motor and a bottom member of the movable window shade for moving the movable window shade.

In accordance with some embodiments of the inventive disclosure, there is provided a method for preserving pleated fabric in an aircraft window shade that includes providing a movable window shade having a pleated fabric material, operating a motor to move the movable window shade between an open position and a closed position during normal operation, wherein the motor stops the movable window shade at a normal operating open position limit and at a normal operating closed position limit, tracking a cycle count representing a number of movements of the movable window shade, and determining, based at least on the cycle count, whether to perform a maintenance operation. Upon determining to perform the maintenance operation, executing a pre-programmed sequence of movements via the motor to restore pleats in the pleated fabric material, the pre-programmed sequence includes causing the motor to move the movable window shade to a position that exceeds the normal operating open position limit for a predetermined duration to apply compression to the pleated fabric material.

In accordance with a further feature, the pre-programmed sequence further includes causing the motor to move the movable window shade to a position that exceeds the normal operating closed position limit for a predetermined duration to apply tension to the pleated fabric material prior to applying the compression.

In accordance with a further feature, the method also includes detecting the normal operating open position limit by sensing a current change in a current input to the motor.

In accordance with a further feature, the method also includes detecting the normal operating closed position limit by sensing a current spike in a current input to the motor.

In accordance with a further feature, the method also includes using a sensor to detect when the movable window shade has reached the normal operating open position limit, and continuing operation of the motor beyond detection by the sensor for the predetermined duration during the maintenance operation.

In accordance with a further feature, the method also includes using a sensor to detect when the movable window shade has reached the normal operating closed position limit, and continuing operation of the motor beyond detection by the sensor for a predetermined duration during the maintenance operation.

In accordance with a further feature, the method also includes storing a cycle table that defines intervals for performing the maintenance operation and levels of compression based on the cycle count, and adjusting the predetermined duration based on the cycle table.

In accordance with a further feature, the method also includes tracking an age of the pleated fabric material, and adjusting an intensity or frequency of the maintenance operation based on the age.

In accordance with a further feature, the maintenance operation is triggered automatically at predefined cycle count intervals or manually via a supervisory system.

In accordance with some embodiments of the inventive disclosure, there is provided a non-transitory computer-readable medium storing instructions that, when executed by a processor in an aircraft shade fabric preservation system, cause the processor to control a motor to move a movable window shade having a pleated fabric material between an open position and a closed position during normal operation, stopping at normal operating position limits, maintain a cycle count of shade movements, determine, based on the cycle count, to initiate a maintenance routine, and in the maintenance routine, direct the motor to exceed at least one of the normal operating position limits for a predetermined period to restore pleats in the pleated fabric material.

Although the invention is illustrated and described herein as embodied in a aircraft shade preservation system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down,” “left,” “right,” “inside,” “outside,” “front,” “back,” “head,” “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first,” “second,” “third,” and so on are only used for descriptive purposes and cannot be construed as indicating or implying relative importance.

In the description of the embodiments of the present invention, it should be noted that, unless otherwise clearly defined and limited, terms such as “installed,” “coupled,” “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure. In this document, the term “longitudinal” should be understood to mean in a direction corresponding to an elongated direction of the article being referenced. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequences of instructions designed for execution on a computer system. Those skilled in the art can understand the specific meanings of the above-mentioned terms in the embodiments of the present invention according to the specific circumstances.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of a foldable pleated window shade inside a window frame, where the window shade is in a closed position.

FIG. 2 is an elevational view of a window shade inside a window frame, where the window shade is in a partially opened position.

FIG. 3A is an edge view of a foldable pleated window shade material of FIGS. 1 & 2 removed from the window frame.

FIG. 3B is a front view of the foldable pleated window shade material of FIGS. 1 & 2 removed from the window frame.

FIG. 4 is a schematic block diagram of a shade control system, in accordance with some embodiments.

FIG. 5 is an elevational view of a shade unit, in accordance with some embodiments.

FIG. 6 is a flow chart diagram of a method of maintaining a shade, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

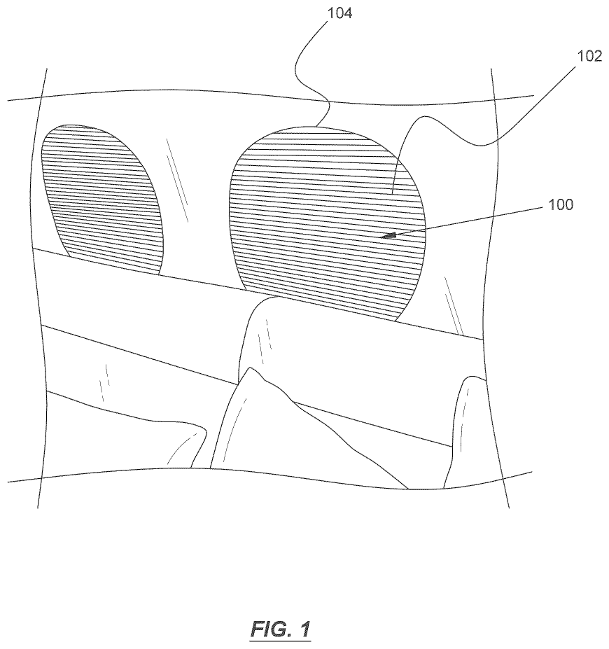

The aircraft shade fabric preservation system integrates an intelligent algorithm into the window shade controller to preserve and restore the fabric's pleated structure. Referring now to FIG. 1, one embodiment of the present invention is shown in a perspective view. The figures show several advantageous features of the present invention, but as will be described below, the invention can be provided in several shapes, sizes, combinations of features and components, and varying numbers and functions of the components. The first example of an aircraft shade fabric preservation system, as shown in FIG. 1, includes a window shade assembly 100 that is comprised of a foldable/pleated material 102. The foldable/pleated material 102, when expanded, obscures a window of the aircraft from the view of one inside an aircraft. The foldable/pleated material 102 can be gathered by moving the lower portion of the shade towards the top to a top position, thereby exposing the window. Similarly, the foldable/pleated material can be expanded from the gathered state to cover or conceal the window by moving the bottom portion of the shade downward to a bottom position while the top potion of the shade remains fixed. The bottom portion of the shade can be moved by a motor that is operably coupled to the bottom of the shade, such as by shafts and/or pulleys which are kept out of sight along the sides of the shade. The normal top and bottom positions can be determined by position sensors in some embodiments, and in some embodiments the top and bottom positions can be determined based on a response by the motor, a duration of time, or similar factors. When the shade is normally moved to fully reveal the window, the bottom of the shade is moved to a nominal position at which the motor then stops moving the bottom of the shade. This is true when the shade is raised, too. There is a nominal top position for normal shade operation at which the shade movement is stopped. But during a maintenance operation, the motor is allowed to act on the shade for a time beyond when it would otherwise stop movement of the shade at the top (or bottom). As a result, the shade can be compressed tighter than is normal in order to re-assert the creases in the shade that create the pleats. This is not done every cycle because the additional force applied to the shade can stress the motor, which can reduce the lifespan of the motor. Further, the shade doesn't need to be re-creased every time it is closed. Depending on the material of the shade, it may last several hundred cycles before needing to be re-creased. Some materials may require more frequent operation, and other materials may last longer between re-creasing operations. Furthermore, depending on the material of the shade, the shade may be stretched periodically prior to a re-creasing operation by allowing the motor to act on the shade for a time beyond when the motor would otherwise stop movement of the shade at the bottom position (shutting the shade).

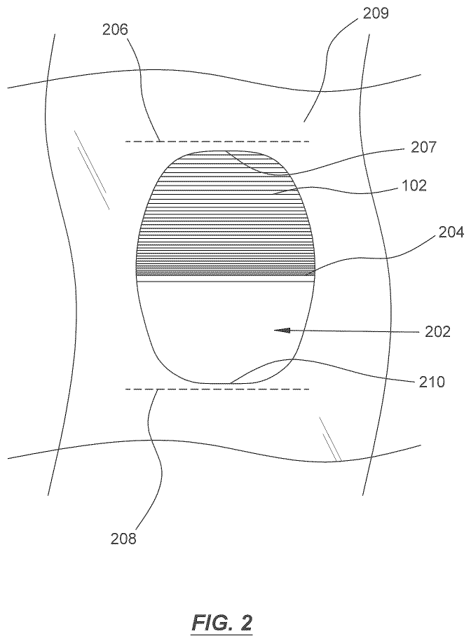

FIG. 2 shows the foldable/pleated material 102 partially compressed and partially exposing a window 202 behind the foldable/pleated material 102. The bottom 204 of the shade material 102 is shown here about midway in the window. When the shade is being opened, the bottom 204 is moved to a nominal top position 206 which is above a top 207 of the window opening of a bezel 209 over the window 202. The bezel 209 is used to conceal all portions of the shade unit other than the shade material 102. Similarly, when the shade is closed, the bottom 204 is move to a bottom nominal position 208 which is below a bottom 210 of the window opening of the bezel 209. The top and bottom nominal positions can be set by sensors that detect when the bottom 204 of the shade is at either the top or bottom nominal position 206, 208. Alternatively, the number of revolutions of the motor can be tracked to determine the position of the bottom 204 of the shade. In some embodiments, the power to the motor moving the bottom 204 of the shade can indicate when the bottom 204 of the shade has reached the top or bottom position 206, 208 since when the bottom 204 of the shade is unable to move further, the power drawn by the motor will suddenly change in response to trying to continue moving the bottom 204 of the shade.

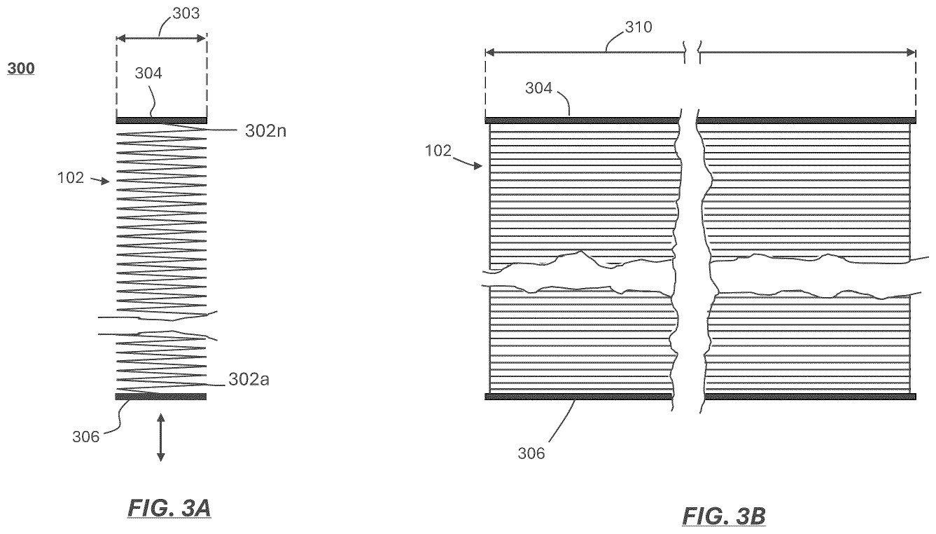

FIG. 3A shows an edge view of the foldable/pleated material 102 used to cover window opening 104. This view shows the foldable/pleated material 102 has a plurality of folds/pleats 302a-n, where “a” equals 1 and “n” can be any number greater than 1. FIG. 3B shows the same material 102 from a front view. The material 102 is attached to top member 304 and a bottom member 306. The bottom member 306 can be the same as the bottom 204 of the shade in FIG. 2. Each of the top and bottom members 304, 306 are rigid flat members having a width 303 that is equal to or wider than the pleats of the material. The top and bottom members 304, 30 can have a length 310 that is as long or longer than material 102 is across, in the horizontal direction. Being rigid and flat, and as wide or wider, and as long or longer than the pleats of the material 102, when the bottom member 306 is urged towards the top member 304 when the material 102 is fully folded, the material 102 is thereby compressed, which re-creases the pleats. This is done, as previously described, by allowing the motor to act on the bottom member 306 beyond what it would when the material 102 were being merely opened during a normal opening operation. The bottom member 306 may not move much beyond the nominal top position (e.g. 206) but there will be considerably more compression applied to the material 102. The exact amount of compression to be applied by the motor can be selected based on the material 102 and the number of cycles at which the re-creasing operation takes places, as determined, for example, through routine experimentation. Further, it has been found that as the shade material 102 ages, it is beneficial to increase the amount/magnitude of the compressive force and/or duration of the application of the compressive force. A schedule can be created based on the number of opening/closing cycles, as well as the real time age of the shade material 102 that adjusts the compression to be applied to the shade material 102 during a compression operation to re-crease the shade material 102. As used herein, the terms “compression,” “compressive force,” and similar terms in the context of the invention refers to allowing the motor, or equivalent driving force for moving the shade, to act on the shade beyond (in time and/or position) when/where it would stop ordinarily upon routinely closing (or opening) the shade.

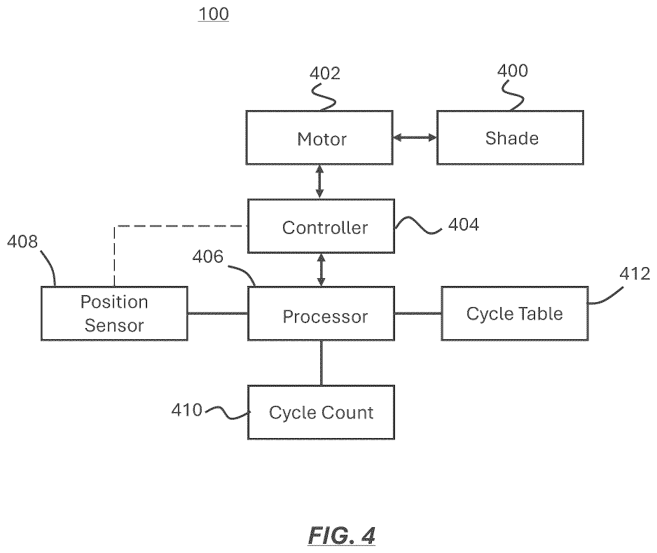

FIG. 4 is a schematic view of the shade assembly 100 and includes a movable shade 400 that is operated by a motor 402. The motor 402 can be controlled by a motor controller 404 that sends signals to the motor 402 and receives feedback from the motor 402 and/or a sensor 408 that senses the position of the bottom of the shade 400. A processor 406 runs computer instructions in the form of programs/algorithms that dictate how the controller 404 instructs the motor 402 to operate. The processor 406 can maintain a cycle count 410 that indicates the number of cycles of opening/closing the moveable shade 400. The cycle count 410 is stored in a non-volatile memory that is operably connected to the processor. Similarly, although not shown here, the processor can store a date or equivalent starting time that is used to track the age of the moveable shade 400. Also stored in memory is a schedule such as a cycle table 412 that indicates when the compression operation is to occur based on a number of opening/closing cycles, as well as an indication as to the level of compression to be applied. In some embodiments, the compression level to be applied can increase with cycle count; that is, for example, more compression is applied (either in actual force or duration, or both) as the cycle count increases, and compression is applied at cycle count intervals. That is, a compression operation is carried out every “n” number of cycles in some embodiments, where “n” is a whole number. In some embodiments the interval can change with cycle count and/or age of the shade. For example, the compression operation can be applied more frequently as the shade ages, in some embodiments. In some embodiments the compression operation can be automatically undertaken when the aircraft is serviced, or at other similar non-flight times.

As shown here, the sensor 408 can provide information to either or both the processor and motor controller 404. The processor can directly operate the motor controller 404, or provide data/instructions to the motor controller for carrying out the compression operation. The sensor can indicate when the moveable portion of the shade 400 is at a final position for opening or closing the shade normally. For a compression operation, either the processor 406 operates the motor controller 404 for a time period beyond when it would shut off the motor controller 404 in response to the sensor indicating that the shade has reached its fully closed state, or the processor 406 instructs the motor controller 404 to do so, and can indicate the duration of additional motive force to be applied to the shade 400 by the motor controller 404. The sensor 408 can be a position sensor such as an optical or magnetic sensor the senses a physical position of the shade 400, or it can be, for example, a counter that counts how many revolutions the motor or another component of the system has made, knowing that there are a finite number of turns of the motor to move the shade from fully closed to fully open, for example. Other types of equivalent sensing can occur to those skilled in the art.

In addition to the elements shown here in FIG. 4, there are also controls that allow a user/passenger to operate the shade. Those controls indicate to the processor 406 to open or close the shade, depending on what input the user/passenger provides. The controls can include, for example an “up” button and a “down” button that cause system to move the shade up or down, respectively, while the button is being pushed. This allows the user/passenger to partially open/close the shade if they do not want it fully open or fully closed. However, if they continue pressing the button when the shade has reached either the top or bottom nominal positions, the processor will cut off the motor unless the opposite button is pushed/actuated, in which case the system will then move the shade in the opposite direction. That is, the user cannot cause a compression operation to occur by holding the button; once the shade moves to either the top or bottom nominal positions, the motor is turned off. Only when a compression operation is indicated as being needed, such as by the stored schedule, will the shade system perform the compression operation. Although it is contemplated that the shade system can be directed to perform a compression operation from a supervisory system, as well, or by pressing/actuating the window shade controls at the window in a preselected sequence.

Thus, the system operates with a shade movement and maintenance routine that includes an algorithm that periodically executes a maintenance cycle to restore the pleats 302a-n in the window shade fabric 102. This cycle involves moving the shade fabric 102 up and down in a predetermined sequence at controlled speeds and distances. Initially, the movements are slower and cover shorter distances. Over time, the movements increase in intensity, eventually achieving full open and close cycles. The shade movement and maintenance routine includes a compression phase where the shade is raised to its fully open position, where the fabric pleats are tightly compressed. The system holds the shade in this compressed position for gradually increasing durations during successive cycles, simulating a pressing process that redefines the pleats'shape and structure.

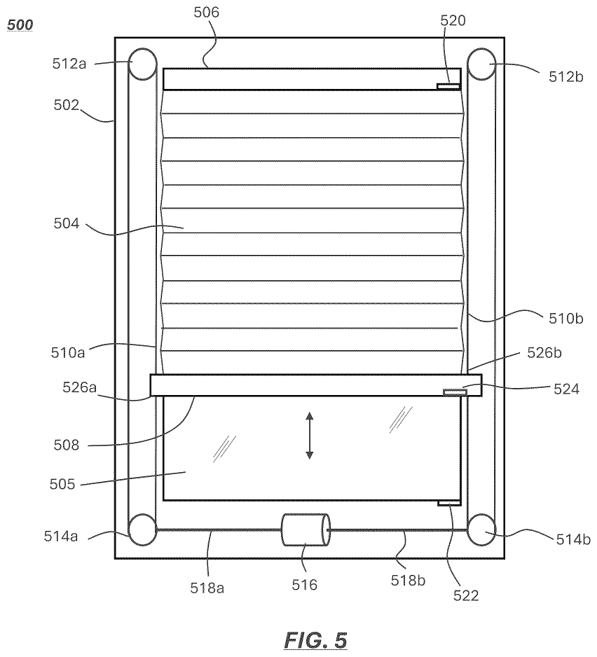

FIG. 5 is an elevational view of a shade unit 500, in accordance with some embodiments. The shade unit 500 is mounted in a frame 502 in alignment with an aircraft window 505. In this view, the bezel that would ordinarily cover the shade unit 500 is not present so that other portions of the shade unit 500 can be seen. Ordinarily, with a bezel present, only the shade 504 and window 505 could be seen through a roughly ovaline opening in the bezel. The shade 504 includes a pleated material connected to a top member 506 and a bottom member 508 at the opposite end of the shade 504. The bottom member 508 can be coupled to lines 510a, 510b which run around pulleys 512a, 514a on one side of the shade 504, and pulleys 512b, 514b on the other side of the shade 504. The bottom member 508 can be attached to lines 510a, 510b at ends 526a, 526b of the bottom member 508, respectively. The lines 510a, 510b are driven by a motor 516 through one or more shafts 518a, 518b that can be operably coupled to the pulley systems. Thus, then the motor 51 turns in a first direction, the pulley systems are driven to move the bottom member 508 of the shade 504 upwards, and when the motor 516 is turned in the opposite direction, the pulley systems are driven to move the bottom member 508 downwards. In some embodiments that can be sensors positioned on the shade 504 and/or at fixed locations relative to the shade system. For example, there can be a top sensor 520 that detects the proximity of the bottom member 508 when the bottom member 508 reaches a nominal top position. The top sensor 520 can interact with a sensor element 524 on the bottom member 508, such as a magnet, or simply an edge of the bottom member 508. The top sensor 520 provides an indication to the processor or motor controller that the bottom member 508 has reached the nominal top position for the shade 504 being fully open. If the shade is simply being opened, then the motor 516 will stop, resulting in the bottom member 508 stopping at the nominal top position. However, if the shade unit is going to perform a compression operation, then when the top sensor 520 indicates that the bottom member 508 has reached to nominal top position, the motor 516 is controlled to continue operating for a period of time to apply compression to the shade 504. The pleated material of the shade 504 is thereby compressed between the top and bottom members 506, 508. A bottom sensor 522 can similarly be used to detect when the bottom member 508 is at the bottom nominal position, where the shade 504 fully covers the aircraft window 505. In some embodiments, the shade 504 can be stretched by allowing the motor 5016 to continue operating after the bottom member 508 has reached the nominal bottom position, as indicated by the bottom sensor 522 as part of the maintenance regime to re-crease the shade 504.

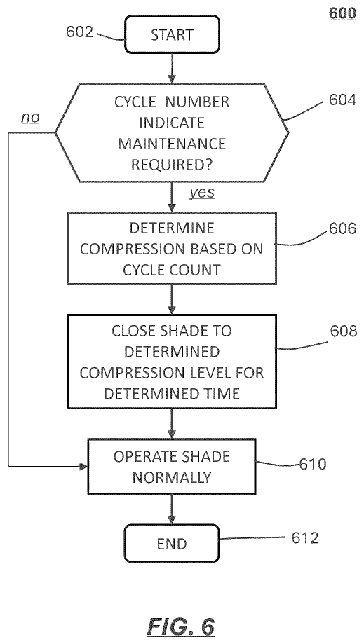

FIG. 6 is a flow chart diagram of a method 600 of maintaining a shade, in accordance with some embodiments. At the start 602, there is a window shade system as described herein provided and ready for operation. In step 604 the shade is moved, either under automatic or personal control (e.g. when a passenger operates the shade controls to open/close the shade). Each time the shade is moved a significant amount, it can be counted as a cycle, and the cycle count can then be incremented, and the new cycle count value checked against the schedule to determine if it is now time to perform a compression operation. If . in step 604, it is determined that a compression operation is to be performed, then in step 606 the amount of compression (in either force, time, or both) is then determined, and applied in step 608. Thereafter, the shade is operated normally. If, in step 604, it is determined that no maintenance or compression operation is to be performed, then the method advances directly to step 610.

As mentioned, as an alternative to using position sensors, in some embodiments the present invention leverages existing motor current monitoring to detect boundary limits during normal operation. During the maintenance routine, the motor's current thresholds are temporarily adjusted to allow tighter compression of the fabric without causing damage. This allows for effective restoration of the pleats 302a-n while maintaining the safety and longevity of the shade mechanism.

The invention is in no way limited to the above-mentioned current-sensing detection method. For example, in one embodiment, the invention includes one or more sensors integrated into the aircraft window assembly that is/are configured to detect the position of the window shade relative to its operational limits. The sensor(s) continuously monitors the movement of the window shade and determines when it has reached either the fully open or fully closed position. Upon detecting one of these limit positions, the sensor generates a signal to the window shade controller, instructing it to stop the motor driving the shade's movement. This feature ensures precise and reliable control of the window shade, preventing overextension or damage to the mechanism. The sensor may utilize technologies such as optical, magnetic, or mechanical detection to accurately identify the shade's position, enhancing both the durability and functionality of the shade system. In accordance with the present invention, when in the maintenance routine, the controller responds to the sensor inputs differently from normal operation and allows the motor to run beyond the normal operation range, thus compressing the shade fabric 102 more than it is compressed in the normal operation range. The compression is intended to restore the folds to the shade material.

The inventive algorithm dynamically can adjust the maintenance parameters based on the shade fabric's age and wear. Older shades may require more frequent or gentler maintenance cycles, whereas newer shades can tolerate higher intensities. The system can operate on a predefined automatic schedule or be activated manually by maintenance personnel.

The presently inventive aircraft shade fabric preservation system offers the following benefits:
Prolonged Shade Lifespan: By restoring the pleats'shape, the system extends the functional and aesthetic life of the window shade fabric.
Reduced Maintenance Costs: Automated preservation reduces the need for frequent replacements or manual repairs.
Improved Passenger Experience: Maintained pleats enhance the cabin's appearance, contributing to overall passenger satisfaction.
Customizability: The system adapts to varying fabric conditions, providing tailored maintenance routines based on the shade's age and wear.

A method and system has been disclosed that provides a novel approach to maintaining aircraft window shade fabric using an intelligent algorithm for periodic restorative maintenance. By automating the preservation process, the system ensures the long-term functionality and appearance of pleated window shades, delivering both operational and aesthetic benefits to aircraft operators.

The claims appended hereto are meant to cover all modifications and changes within the scope and spirit of the present invention.

What is claimed is:

1. An aircraft shade fabric preservation system comprising:
a moveable window shade of a pleated fabric material;
a motor operable to move the moveable window shade from an open position to a closed position;
a controller communicatively coupled to the motor and operable to cause the motor to stop the movable window shade at a normal operating open position limit and at a normal operating closed position limit; and
a processor communicatively coupled to the controller and operable to execute an algorithm that causes the controller to cause the moveable window shade to perform a pre-programmed sequence of movements via the motor to restore the pleats of the shade fabric, the pre-programmed sequence of movements including causing the motor to stop the movable window shade at a position that exceeds the normal operating open position limit and at a position that exceeds the normal operating closed position limit.

2. The aircraft shade fabric preservation system of claim 1, wherein:
the normal operating open position is detected by the sensing current spikes on the motor's current input.

3. The aircraft shade fabric preservation system of claim 1, wherein:
the normal operating closed position is detected by the sensing current spikes on the motor's current input.

4. The aircraft shade fabric preservation system of claim 1, further comprising:
a sensor communicatively coupled to the motor or to the controller and operable to detect when the normal operating open position of the moveable window shade has been reached.

5. The aircraft shade fabric preservation system of claim 1, further comprising:
a sensor communicatively coupled to the motor or to the controller and operable to detect when the normal operating closed position of the moveable window shade has been reached.

6. The aircraft shade fabric preservation system of claim 1, further comprising:
a non-volatile memory coupled to the processor for storing the cycle count and a cycle table defining compression levels and intervals for the pre-programmed sequence.

7. The aircraft shade fabric preservation system of claim 1, wherein the processor is further operable to track an age of the pleated fabric material and adjust a duration or force of exceeding the normal operating open position limit based on the age.

8. The aircraft shade fabric preservation system of claim 1, further comprising:
a top rigid member and a bottom rigid member attached to opposite ends of the pleated fabric material, wherein exceeding the normal operating open position limit compresses the pleated fabric material between the top rigid member and the bottom rigid member.

9. The aircraft shade fabric preservation system of claim 1, wherein the pre-programmed sequence includes a series of partial movements at varying speeds and distances prior to exceeding the normal operating open position limit.

10. The aircraft shade fabric preservation system of claim 1, further comprising:
a pulley system operably coupled to the motor and a bottom member of the movable window shade for moving the movable window shade.

11. A method for preserving pleated fabric in an aircraft window shade, comprising:
providing a movable window shade having a pleated fabric material;
operating a motor to move the movable window shade between an open position and a closed position during normal operation, wherein the motor stops the movable window shade at a normal operating open position limit and at a normal operating closed position limit;
tracking a cycle count representing a number of movements of the movable window shade;
determining, based at least on the cycle count, whether to perform a maintenance operation; and
upon determining to perform the maintenance operation, executing a pre-programmed sequence of movements via the motor to restore pleats in the pleated fabric material, the pre-programmed sequence including causing the motor to move the movable window shade to a position that exceeds the normal operating open position limit for a predetermined duration to apply compression to the pleated fabric material.

12. The method of claim 11, wherein the pre-programmed sequence further includes causing the motor to move the movable window shade to a position that exceeds the normal operating closed position limit for a predetermined duration to apply tension to the pleated fabric material prior to applying the compression.

13. The method of claim 11, further comprising:
detecting the normal operating open position limit by sensing a current spike in a current input to the motor.

14. The method of claim 11, further comprising:
detecting the normal operating closed position limit by sensing a current spike in a current input to the motor.

15. The method of claim 11, further comprising:
using a sensor to detect when the movable window shade has reached the normal operating open position limit; and
continuing operation of the motor beyond detection by the sensor for the predetermined duration during the maintenance operation.

16. The method of claim 11, further comprising:
using a sensor to detect when the movable window shade has reached the normal operating closed position limit; and
continuing operation of the motor beyond detection by the sensor for a predetermined duration during the maintenance operation.

17. The method of claim 11, further comprising:
storing a cycle table that defines intervals for performing the maintenance operation and levels of compression based on the cycle count; and
adjusting the predetermined duration based on the cycle table.

18. The method of claim 11, further comprising:
tracking an age of the pleated fabric material; and
adjusting an intensity or frequency of the maintenance operation based on the age.

19. The method of claim 11, wherein the maintenance operation is triggered automatically at predefined cycle count intervals or manually via a supervisory system.

20. A non-transitory computer-readable medium storing instructions that, when executed by a processor in an aircraft shade fabric preservation system, cause the processor to:
control a motor to move a movable window shade having a pleated fabric material between an open position and a closed position during normal operation, stopping at normal operating position limits;
maintain a cycle count of shade movements;
determine, based on the cycle count, to initiate a maintenance routine; and
in the maintenance routine, direct the motor to exceed at least one of the normal operating position limits for a predetermined period to restore pleats in the pleated fabric material.
